(19) United States
(12) Patent Application Publication
(10) Pub. No.: US 2009/0134686 A1
(43) Pub. Date: May 28, 2009

(54) Vehicle seat

(75) Inventors: Tadashi Naito, Saitama (JP); Yuta Urushiyama, Saitama (JP); Koichi Suyama, Saitama (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 12/291,838

(22) Filed: Nov. 13, 2008

(30) Foreign Application Priority Data
Nov. 27, 2007 (JP) 2007-305465

(51) Int. Cl. A47C 7/20; B60N 2/44

(52) U.S. Cl. 297/452.55

(57) ABSTRACT

A vehicle seat which comprises a seat cushion, a frame for the seat cushion, and a seat pan supported by the seat cushion frame. A surface of the seat pan is covered with a cushion material, and a cutout is formed in a front portion of the seat pan. The cutout is shaped such that a leg of an occupant sitting on the seat cushion can fit in the cutout while deforming the cushion material.

### CROSS-REFERENCE TO RELATED APPLICATIONS

The present invention claims priority under 35 USC §119 based on Japanese patent application No. 2007-305465 filed 27 Nov. 2007. The subject matter of this priority document is incorporated by reference herein.

### BACKGROUND OF THE INVENTION

1. Field of the Invention

The present invention relates to a vehicle seat in which a seat pan is supported by a frame of a seat cushion, and a surface of the seat pan is covered with a cushion material. More particularly, the present invention relates to such a vehicle seat having a structure which improves the safety of an occupant in the event of a collision.

2. Description of the Related Art

There is known a vehicle seat including an unlocking device that unlocks a seat slide adjusting device, which supports the seat on a floor panel adjustably in front and rear positions, when legs of an occupant on the seat are caught between an instrument panel and a cushion of the seat at the time of a head-on collision of an automobile. The unlocking device is provided to allow the seat to be slid rearwardly along a seat rail of the slide adjusting device and allow rescue of the occupant whose legs would otherwise remain caught between the instrument panel and the seat cushion. See Japanese Patent Application Laid-open No. 10-119614.

In the above described conventional seat, the unlocking device is activated simultaneously with deformation of the instrument panel or an input of a collision load, and thus the seat slide adjusting device may be unlocked before the vehicle stops to cause a secondary collision. However, even with the known unlocking device, if the seat is to be slid rearwardly after the vehicle stops, an impact of the collision may deform the seat rail to render the seat incapable of sliding.

### SUMMARY OF THE INVENTION

The present invention is achieved in view of the above described circumstances, and has an object to better prevent legs of an occupant from being caught between a dashboard and a seat cushion, and allow easy rescue of the occupant even if the occupant's legs are caught between the instrument panel and the seat cushion.

In order to achieve the above object, according to a first feature and aspect of the present invention, there is provided a vehicle seat comprising: a seat cushion; a frame for the seat cushion; and a seat pan supported by the seat cushion frame, wherein a surface of the seat pan is covered with a cushion material, a cutout is formed in a front portion of the seat pan, and the cutout is shaped such that a leg of an occupant sitting on the seat cushion can fit in the cutout while deforming the cushion material.

With the configuration of the first feature and aspect, the cutout is formed in the front portion of the seat pan supported by the seat cushion frame and has the surface covered with the cushion material. Thus, when a vehicle body member, such as a dashboard, is retracted at the time of a collision of the vehicle and the leg(s) of the occupant sitting on the seat cushion is/are caught between the vehicle body member and the seat cushion, the occupant's leg(s) can fit in the cutout while deforming the cushion material, thereby minimizing an impact on the leg(s) of the occupant, and allowing the leg(s) of the occupant to be easily removed from between the vehicle body member and the seat cushion.

According to a second feature and aspect of the present invention, in addition to the first feature and aspect, the cutout is formed in a middle portion in a vehicle width direction of the front portion of the seat pan.

With the configuration of the second feature and aspect, the cutout is formed in the middle portion in the vehicle width direction of the front portion of the seat pan, thereby allowing left and right legs of the occupant to escape into the cutout.

According to a third feature and aspect of the present invention, in addition to the first feature and aspect, a cutout is formed in one side in the vehicle width direction of the front portion of the seat pan and another cutout is formed in the opposite side in the vehicle width direction of the front portion of the seat pan.

With the configuration of the third feature and aspect, the two cutouts are formed in the opposite sides in the vehicle width direction of the front portion of the seat pan, thereby allowing the left and right legs of the occupant to escape into the two cutouts, respectively.

According to a fourth feature and aspect of the present invention, in addition to any of the first to third features and aspects, the vehicle seat further comprises a fragile cushion material holding member provided in the cutout(s) and which supports the cushion material.

With the configuration of the fourth feature and aspect, the fragile cushion material holding member that supports the cushion material is provided in the cutout in the seat pan. Thus, the cushion material holding member can support the cushion material to ensure sitting comfort in normal time, but because it is fragile the cushion material holding member can be easily broken or deformed by an impact at the time of a collision of the vehicle, thereby allowing the leg(s) of the occupant to reliably escape into the cutout in the seat pan.

According to a fifth feature and aspect of the present invention, in addition to any of the first to fourth features and aspects, comb-teeth shaped slits extending toward a front of a vehicle body are formed in a portion of the cushion material covering the cutout(s).

With the configuration of the fifth feature and aspect, the comb-teeth shaped slits extending toward the front of the vehicle body are formed in the portion of the cushion material covering the cutout in the seat pan. Thus, the cushion material can be easily deformed by the slits at the time of a collision of the vehicle, thereby allowing the leg(s) of the occupant to reliably escape into the cutout in the seat pan.

Now, exemplary embodiments of the present invention will be described with reference to the accompanying drawings.

### BRIEF DESCRIPTION OF THE DRAWINGS

FIGS. 1 to 5 show a first exemplary embodiment of a vehicle seat according to the present invention, in which:

FIG. 1 is a plan view of a driver's seat of an automobile;

FIG. 2 is a sectional view taken along the line 2-2 in FIG. 1;

FIG. 3 is a sectional view taken along the line 3-3 in FIG. 2;

FIG. 4 is an exploded perspective view of a seat pan and a cushion material of the driver's seat; and

FIG. 5 illustrates an operation of the driver's seat at the time of a head-on collision of a vehicle.

FIGS. 6 and 7 show a second exemplary embodiment of a vehicle seat according to the present invention, in which:

FIG. 6 is a plan view of a driver's seat of an automobile; and

FIG. 7 is an exploded perspective view of a seat pan and a cushion material of the driver's seat.

FIGS. 8A, 8B and 9 show a third exemplary embodiment of a vehicle seat according to the present invention, in which:

FIG. 8A is a plan view of a driver's seat of an automobile prior to collision;

FIG. 8B is a plan view of the driver's seat after collision; and

FIG. 9 is an exploded perspective view of a seat pan and a cushion material of the driver's seat.

FIG. 10 is an exploded perspective view of a seat pan and a cushion material according to a fourth exemplary embodiment of a vehicle seat according to the present invention.

FIG. 11 is an exploded perspective view of a seat pan and a cushion material according to a fifth exemplary embodiment of a vehicle seat according to the present invention.

### DESCRIPTION OF THE PRESENT EMBODIMENTS

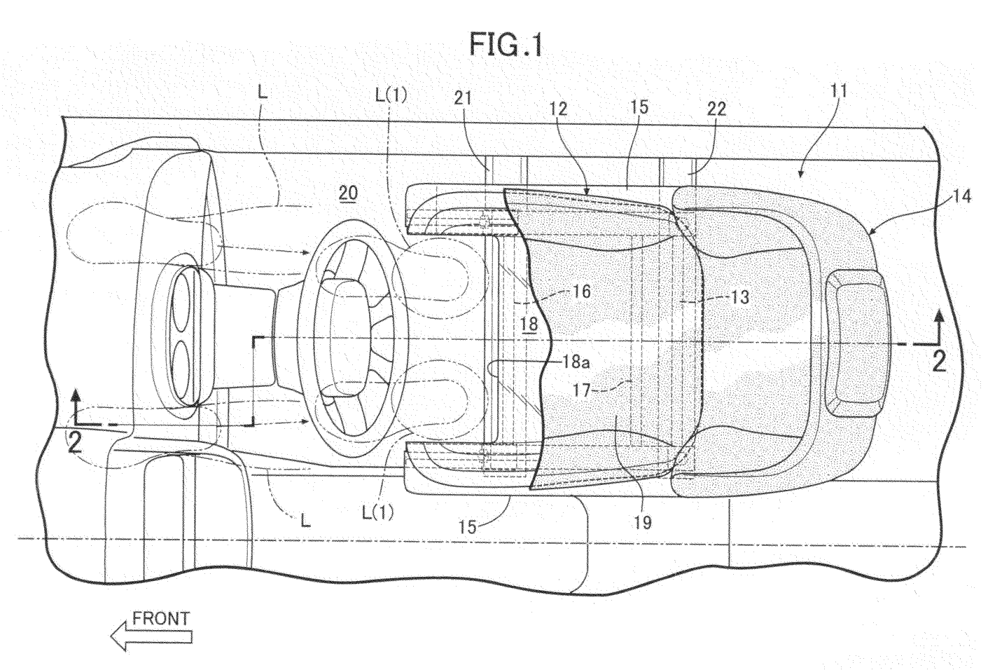

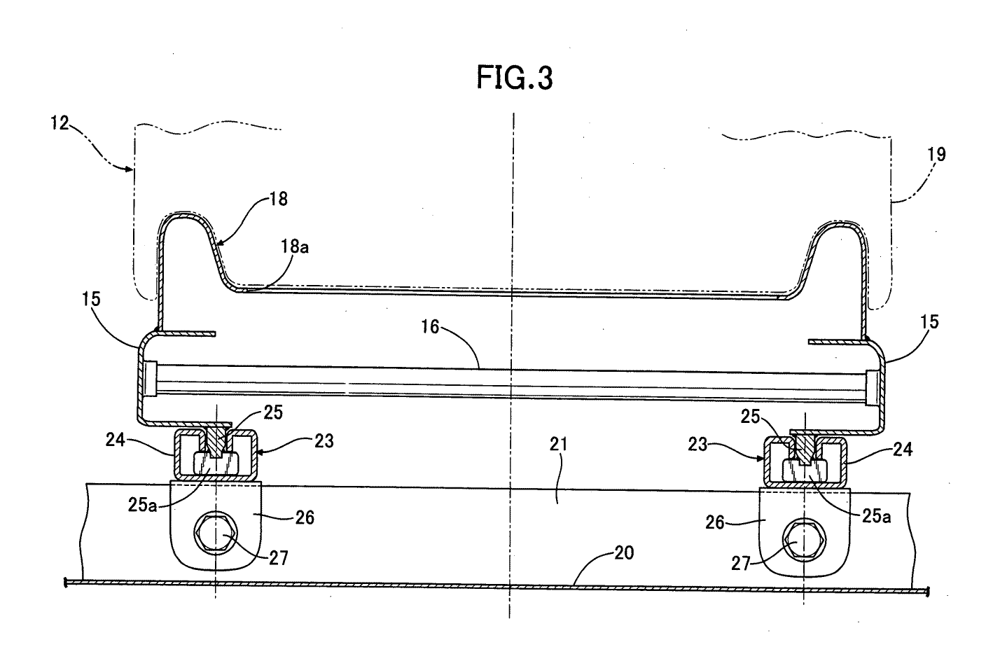

As shown in FIGS. 1 to 3, a front seat 11 that is a driver's seat of an automobile includes a seat cushion 12 on which an occupant sits, and a seatback 14 having a lower end pivoted at a rear end of the seat cushion 12 by a reclining shaft 13. Frames of the seat cushion 12 include left and right side frames 15 and 15, and a front connecting frame 16 and a rear connecting frame 17 that connect the side frames 15 and 15 in a vehicle width direction, and an upper surface of a seat pan 18 made by pressing sheet metal and placed on the side frames 15 and 15 is covered with an elastic cushion material 19.

On an upper surface of a floor panel 20, a front cross member 21 and a rear cross member 22 extending in the vehicle width direction are secured. On the front cross member 21 and the rear cross member 22, the seat cushion 12 is supported adjustably in various front and rear positions thereof via a pair of left and right seat rails 23 and 23 extending in a front-rear direction of a vehicle body. Each seat rail 23 includes a fixed rail 24 on a lower side and a movable rail 25 on an upper side, and a front bracket 26 provided on a front portion of the fixed rail 24 is secured to the front cross member 21 by a bolt 27, and a rear bracket 28 provided on a rear end of the fixed rail 24 is secured to the rear cross member 22 by a bolt 29. The movable seat rail 25 secured on a lower surface of each side frame 15 of the seat cushion 12 includes a pair of front and rear sliders 25a and 25a, and the sliders 25a and 25a slidably engage the inside of the fixed rail 24.

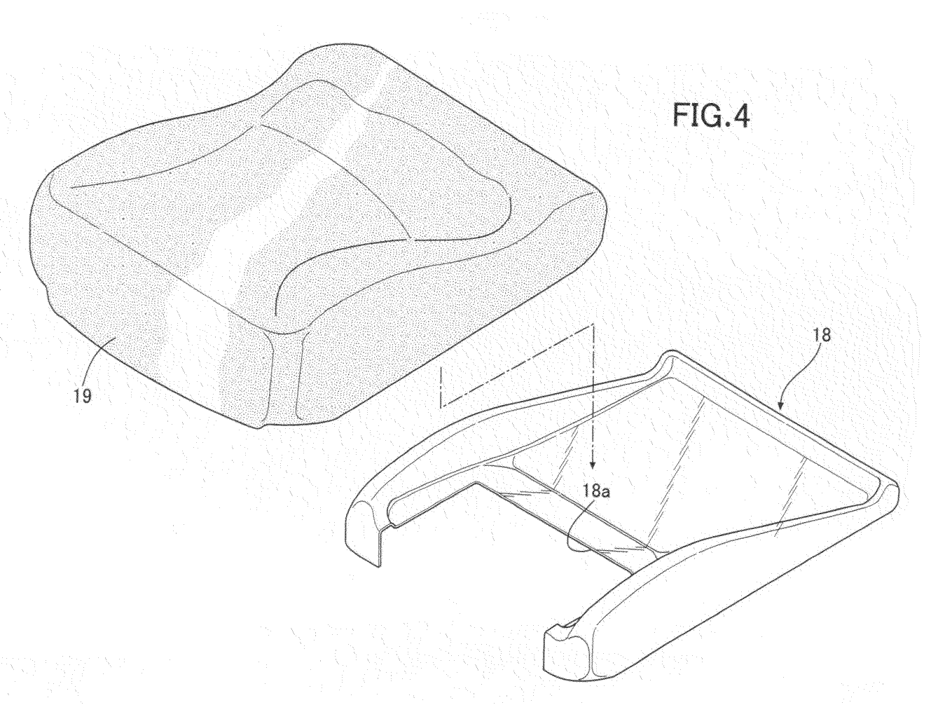

As is apparent from FIG. 4, in a middle portion of a front edge portion of the seat pan 18 covered with the cushion material 19, a cutout 18a recessed rearwardly in a square shape is formed. The cutout 18a is hidden from outside view in a state where the seat pan 18 is covered with the cushion material 19.

A side frame 15, a front connecting frame 16 and a rear connecting frame 17 in the above exemplary embodiment correspond to the frames in the present invention.

Next, an operation of the first exemplary embodiment of the present invention including the above described configuration will be described.

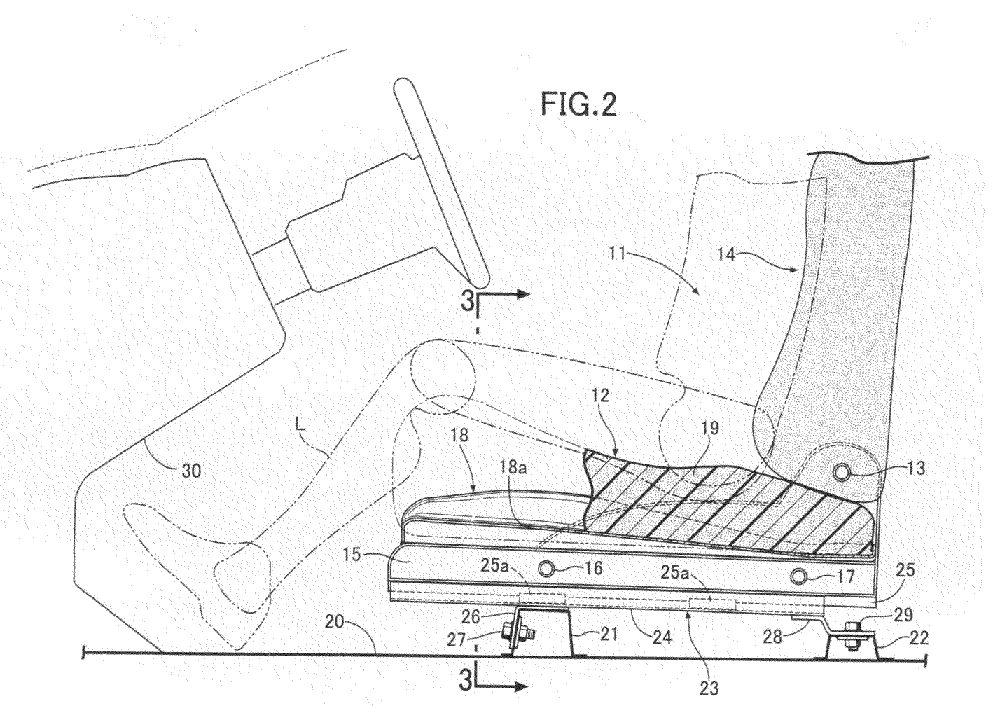

In a normal operation state shown in FIG. 2, there is sufficient space between a front end of the front seat 11 and a dashboard 30, and legs L and L of the occupant sitting on the front seat 11 are placed in the space between the front seat 11 and the dashboard 30.

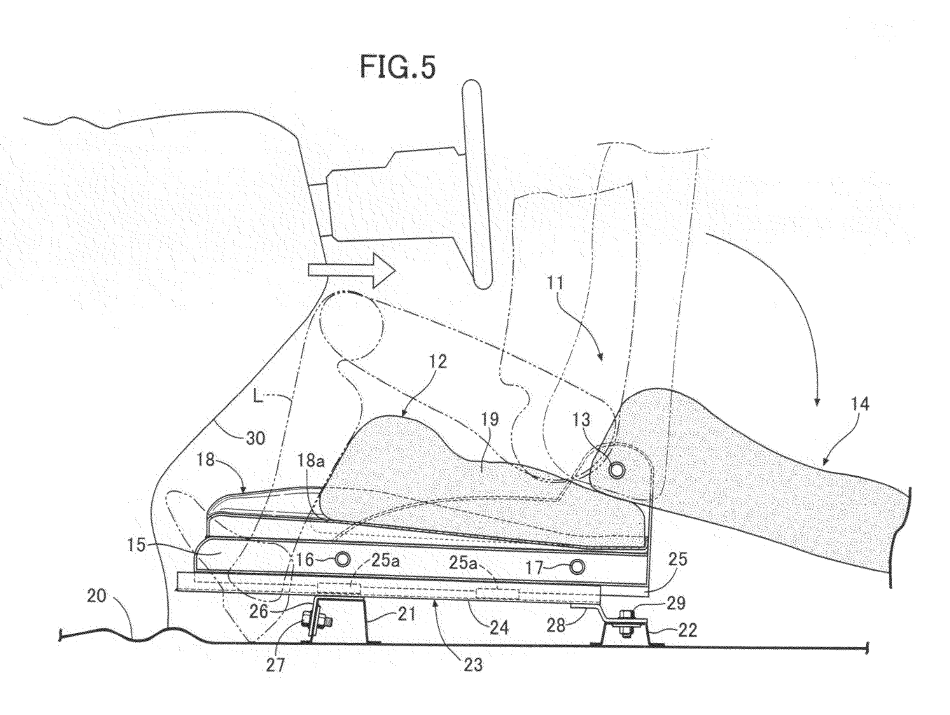

As shown in FIG. 5, the dashboard 30 is retracted into a vehicle compartment at the time of a head-on collision of the vehicle, and thus the legs L and L of the occupant sitting on the front seat 11 may be pressed rearward by the dashboard 30 and then caught between the dashboard 30 and a front edge portion of the seat cushion 12 of the front seat 11. However, in the first exemplary embodiment, the cutout 18a is formed in the front edge portion of the seat pan 18 of the seat cushion 12, and thus the legs L and L of the occupant fit into the inside of the cutout 18a while pressing the elastic cushion material 19 rearward (see legs L(1) and L(1) in FIG. 1), thereby reducing an impact of the retracted dashboard 30 on the legs.

Also, the legs L and L of the occupant are not firmly caught between the dashboard 30 and the seat pan 18, and thus the seatback 14 may be reclined rearwardly to allow the legs L and L of the occupant to be removed from the cutout 18a in the seat pan 18 and allow easy rescue of the occupant from the damaged vehicle.

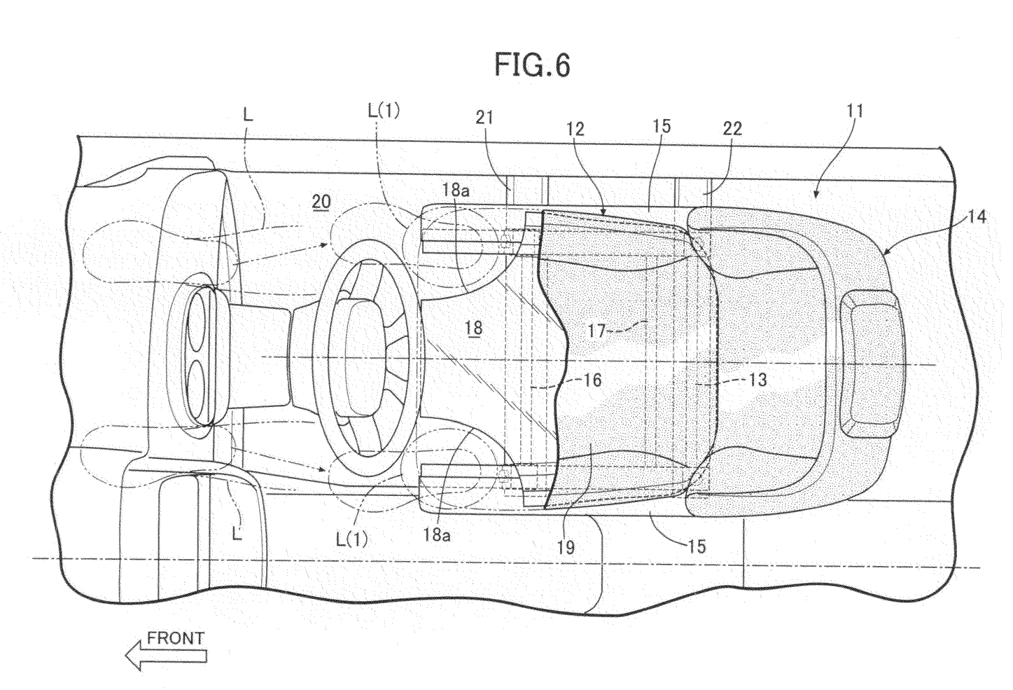

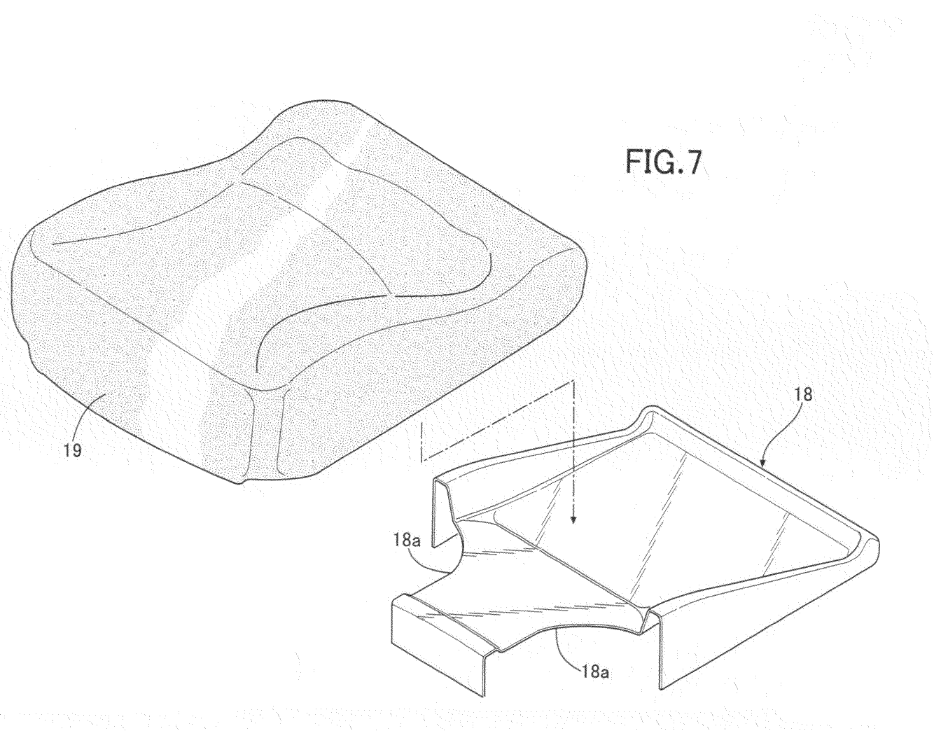

FIGS. 6 and 7 show a second exemplary embodiment of the present invention.

In the above described first exemplary embodiment, the single cutout 18a is formed in the middle portion of the front edge of the seat pan 18, while in the second exemplary embodiment, cutouts 18a and 18a are formed in left and right sides of the front edge portion of the seat pan 18. According to the second exemplary embodiment, at a head-on collision of the vehicle, left and right legs L and L of the occupant fit into the left and right cutouts 18a and 18a, respectively, in the seat pan 18, thereby reducing an impact of the collision and facilitating an escape of the passenger from the vehicle.

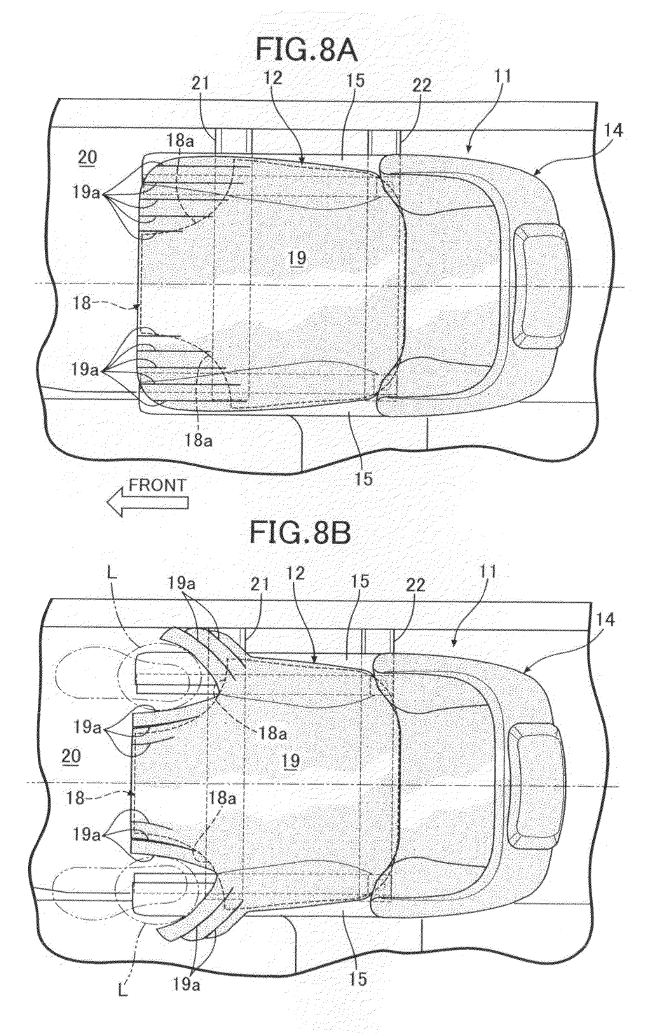

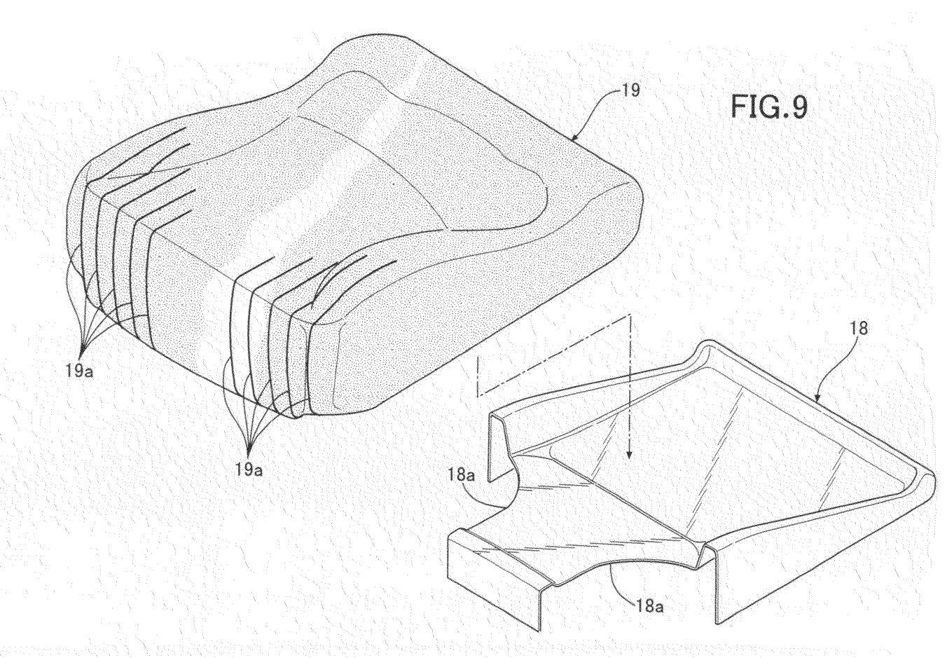

FIGS. 8A, 8B and 9 show a third exemplary embodiment of the present invention.

The third exemplary embodiment is a variant of the above described second exemplary embodiment, in which a plurality of slits 19a extending toward a front of the vehicle body are formed parallel to each other in portions of the cushion material 19 in positions corresponding to the left and right cutouts 18a and 18a in the seat pan 18. Since the cushion material 19 is covered with a cover, the slits 19a are hidden from outside view.

Thus, when the left and right legs L and L of the occupant fit into the left and right cutouts 18a and 18a, respectively, in the seat pan 18 at the time of a head-on collision of the vehicle, the cushion material 19 having the plurality of slits 19a is easily deformed to allow the left and right legs L and L of the occupant to be smoothly led into the cutouts 18a and 18a.

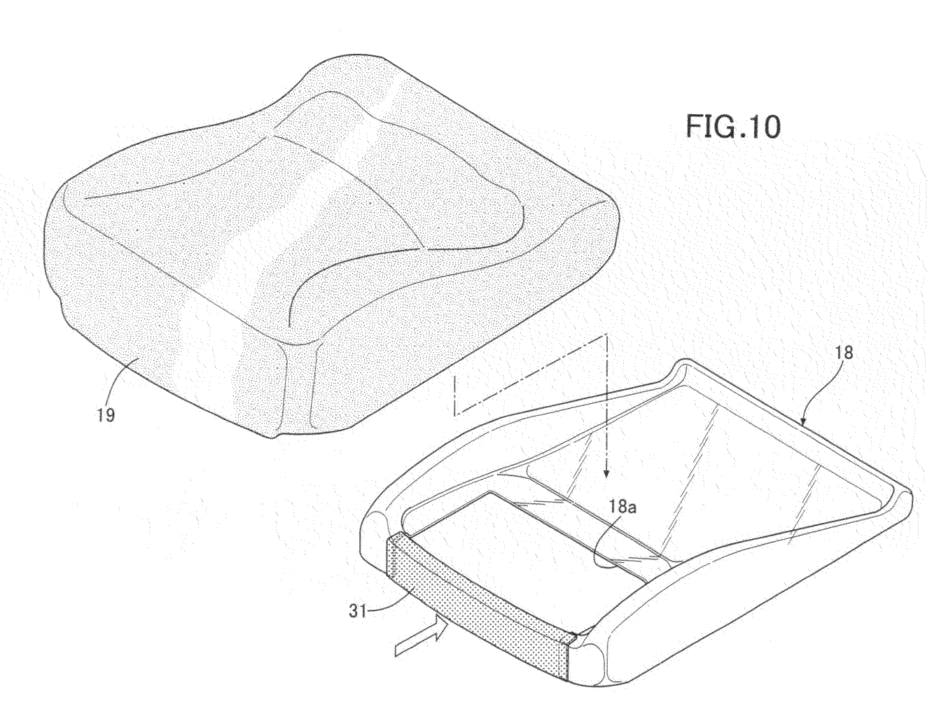

Next, the fourth exemplary embodiment of the present invention will be described with reference to FIG. 10.

The fourth exemplary embodiment is a variant of the above described first exemplary embodiment, in which a cushion material holding member 31 that is fragile to a load in the front-rear direction of the vehicle and, for example, made of synthetic resin is placed so as to cover an opening of the cutout 18a in the middle portion of the seat pan 18.

When the cutout 18a is formed in the seat pan 18, the cushion material 19 may be unstably supported, and a front portion of the cushion material 19 may sink by the weight of the occupant sitting thereon to reduce sitting comfort. Thus, according to the fourth exemplary embodiment, the front portion of the cushion material 19 is supported from below by the cushion material holding member 31, thereby preventing the cushion material 19 from sinking, and increasing the occupant's sitting comfort.

When a load from the front is applied at the time of a head-on collision of the vehicle, the fragile cushion material holding member 31 is easily broken or deformed to allow the legs L and L of the occupant to pass therethrough.

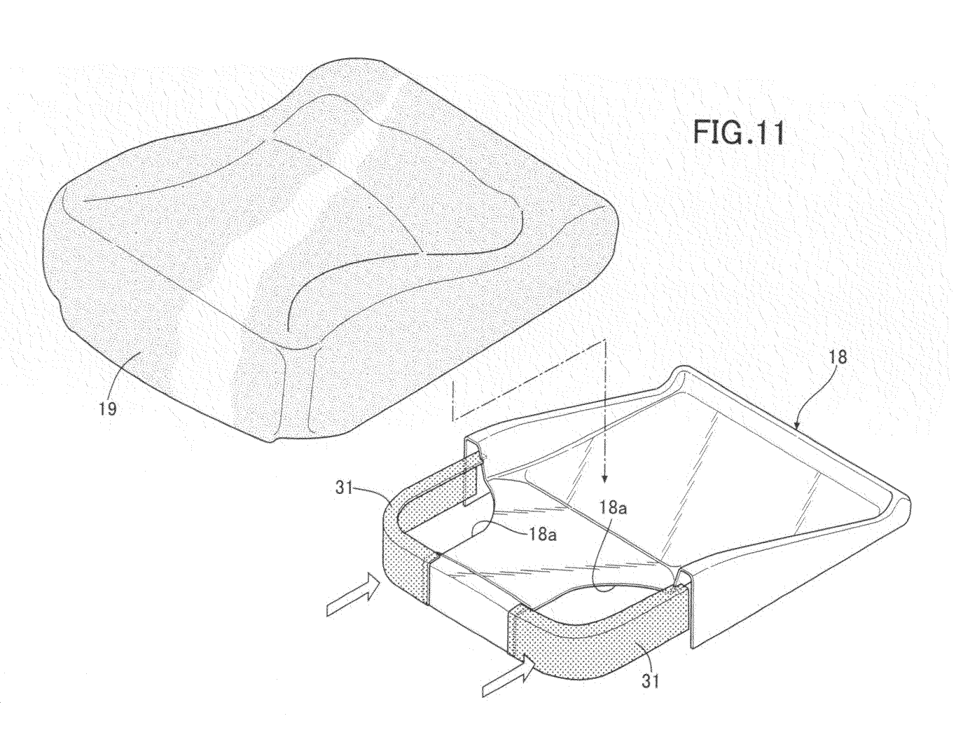

Next, the fifth exemplary embodiment of the present invention will be described with reference to FIG. 11.

The fifth exemplary embodiment is a variant of the above described fourth exemplary embodiment, in which fragile cushion material holding members 31 and 31 made of synthetic resin, for example, are placed so as to cover openings of the cutouts 18a and 18a in the left and right ends of the seat pan 18. Also, according to the fifth exemplary embodiment, the same operation and effect as the above described fourth exemplary embodiment can be achieved.

The exemplary embodiments of the present invention have been described as above, but the present invention is not limited to the above exemplary embodiments, and various design choices and other modifications may be made without departing from the scope of the present invention described in Claims.

For example, in the exemplary embodiments, the front seat 11 for the driver seat is exemplified, but the present invention may be applied to a front seat for a passenger seat.

What is claimed is:

1. A vehicle seat comprising:
a seat cushion;
a frame for the seat cushion; and
a seat pan supported by the seat cushion frame, wherein
a surface of the seat pan is covered with a cushion material, a cutout is formed in a front portion of the seat pan, and the cutout is shaped such that a leg of an occupant sitting on the seat cushion can fit in the cutout while deforming the cushion material.

2. The vehicle seat according to claim 1, wherein the cutout is formed in a middle portion in a vehicle width direction of the front portion of the seat pan.

3. The vehicle seat according to claim 1, wherein said cutout is formed in one side in the vehicle width direction of the front portion of the seat pan and another cutout is formed in the opposite side in the vehicle width direction of the front portion of the seat pan.

4. The vehicle seat according to claim 1, wherein the vehicle seat further comprises a fragile cushion material holding member provided in the cutout and which supports the cushion material.

5. The vehicle seat according to claim 2, wherein the vehicle seat further comprises a fragile cushion material holding member provided in the cutout and which supports the cushion material.

6. The vehicle seat according to claim 3, wherein the vehicle seat further comprises fragile cushion material holding members provided in the cutouts and which support the cushion material.

7. The vehicle seat according to claim 1, wherein comb-teeth shaped slits extending toward a front of a vehicle body are formed in a portion of the cushion material covering the cutout.

8. The vehicle seat according to claim 2, wherein comb-teeth shaped slits extending toward a front of a vehicle body are formed in a portion of the cushion material covering the cutout.

9. The vehicle seat according to claim 3, wherein comb-teeth shaped slits extending toward a front of a vehicle body are formed in portions of the cushion material covering the cutouts.

10. The vehicle seat according to claim 4, wherein comb-teeth shaped slits extending toward a front of a vehicle body are formed in a portion of the cushion material covering the cutout.

11. The vehicle seat according to claim 5, wherein comb-teeth shaped slits extending toward a front of a vehicle body are formed in a portion of the cushion material covering the cutout.

12. The vehicle seat according to claim 6, wherein comb-teeth shaped slits extending toward a front of a vehicle body are formed in portions of the cushion material covering the cutouts.
